(19) United States
(12) Patent Application Publication
(10) Pub. No.: US 2018/0197245 A1
(43) Pub. Date: Jul. 12, 2018

(54) METHOD FOR FUNDING TAX-DEFERRED RETIREMENT OR SAVINGS ACCOUNTS VIA DEBT INSTRUMENTS

(71) Applicant: Carlos M. Barrera, Hialeah, FL (US)

(72) Inventor: Carlos M. Barrera, Hialeah, FL (US)

(21) Appl. No.: 15/401,159

(22) Filed: Jan. 9, 2017

(51) Int. Cl. G06Q 40/06; G06Q 20/24; G06Q 40/00; G06Q 30/02; G06Q 40/04; G06Q 30/04

(52) U.S. Cl. CPC G06Q 40/06; G06Q 20/24; G06Q 30/04; G06Q 30/0232; G06Q 40/04; G06Q 40/123

(57) ABSTRACT

A portable device, which encompasses both a debt instrument such as a credit card and a savings instrument, which funds a TDS plan, is provided. The portable device allows a method, which includes providing a Statement having at least one section, which allows CCHs to select one, or a combination of a group of tax deferred investment accounts to receive the periodic monetary contribution, each representing a different level of risk. The method further includes providing a section within said Statement that allows for the CCH to specify TDS plans owned or controlled by third parties that will receive all or part of the periodic contribution made by the CCH, or whether the value of any one plan which the CCH or a third party controls will be transferred or liquidated. The method further includes providing the CCHs the option to allocate all or a portion of the cash-back rewards earned during a certain billing statement to the TDS account.

### BACKGROUND OF THE INVENTION

### Field of the Invention

The invention relates generally to the funding of tax-deferred accounts that enable the participants to invest and intelligently plan for their retirement savings needs.

### Description of the Related Art

Policy-makers and researchers have an acute interest in the growth of pension plans and their relationship in influencing work and retirement, saving and consumption, and well-being in old age. Analysts concerned about poverty and income sufficiency acknowledge that pensions play a key role in the well-being of the elderly. Traditional pension plans, such as defined benefit plans that promised each employee a certain amount of his or her salary at retirement, placed responsibility for retirement planning for each employee on the employer, making the employer a “fiduciary.” However, over the past several years, there has been a shift from defined benefit plans to self-directed defined contribution plans, such as 401(k) plans. Consequently, with the proliferation of 401(k) plans, responsibility for retirement planning has shifted away from the employer and now rests squarely on the shoulders of each individual plan participant.

In 1995, researcher John Shoven confirmed that pension assets grew faster than total wealth in the United States during the 1980s, leading Shoven to conclude, “pensions are how America saves.” At the same time that pension wealth has grown, there has been a revolution in the pension industry, as defined contribution plans, and 401(k) plans in particular, have become the pension plans of choice. Defined contribution plans increased from 13 to 30 percent between 1975 and 1985 and then to 42 percent in 1992. By 1997, defined contribution plans rose to 53 percent. See Defined Contribution Plan Dominance Grows Across Sectors . . . , special report by Kelly Olsen and Jack Van Derhei, Employee Benefit Research Institute, October 1997, Special Report 190, Washington, D.C. Most of the contributions are coming directly from workers.

The overwhelming majority of workers participating in 401(k) plans are required to manage the investment of their retirement savings directly. In this brave new world, workers not only have to determine when to start saving for retirement and how much to contribute to their retirement accounts, they also must decide how to allocate their retirement funds across various types of assets. Tax-deferred account participants understand that they are not prepared to make basic investment decisions, which are necessary in order for them to achieve their retirement goals. Faced with overwhelming doubt, participants often turn to coworkers, friends, and the anecdotal information they read in newspaper and magazine articles for guidance in making their investment decisions.

Accordingly, it would be a significant advancement in the art to provide a method of automatically funding tax-deferred accounts that enable the participants to realize the benefits of tax-deferred accounts and to be able to forecast and intelligently plan for their retirement savings needs.

### BRIEF SUMMARY OF THE INVENTION

Embodiments of the present invention address deficiencies of the art and provide a novel and non-obvious method for effortlessly contributing a periodic or non-periodic monetary sum to a tax deferred account. For example, in a preferred embodiment, a portable device is provided with both a credit card capability and a tax deferred savings capability.

In accordance with an embodiment of the invention, monthly credit card statements provided to CCHs (“CCH”) display different tax-deferred savings or retirement (“TDS”) accounts, with each TDS account being categorized by its separate investment risk level. Further, each credit card statement (“Statement”) will include a blank or open field for a CCH to specify an already-existing TDS account not already present in the risk-stratified listing provided.

The Statement will also include multiple funding options. A first option will allow a CCH the ability to simply have the credit card company fund the desired TDS from the line of credit available to the CCH. A second option will allow the CCH ability to fund the TDS using loyalty or reward points earned as a result of prior purchases or bonuses. To accomplish this second option, the Statement will contain a separate option, displaying the total amount of loyalty or rewards points available to the CCH, and their currency equivalent. If the CCH chooses this second option, the currency equivalent will be sent to the CCH-selected TDS. Of course, CCHs will have the option of apportioning some of the cash equivalence related to the loyalty or reward points, instead of depositing the entire monetary sum into the tax-deferred account.

It is understood that this second funding option, permitting CCHs to fund the TDS by using the cash-equivalents of loyalty or reward points, can be combined with the first option allowing CCHs the ability to simply have the credit card company fund the desired TDS from the line of credit available to the CCH. In other words, CCHs may choose to fund the TDS with both funds drawn from the credit line and funds drawn from the loyalty or reward program cash equivalence.

Yet a third option includes the ability of CCHs to fund a TDS by sending to the credit card company, in addition to the balance due as a result of the usage of the credit card, an additional periodic stipend. Additionally, CCHs may be able to contribute to their own TDS account, as well as the TDS account of third parties like their employees or their family members. Each TDS is fully transferable and assignable and CCHs may be able to transfer or apportion funds freely among them.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 shows a Statement denoted as Plan A that is used by the CCH for oneself. It contains fields displaying which reward features one can select to send, or convert to its cash equivalent and send, to the various TDS options. It also has an option to send a fixed amount per billing period to the TDS.

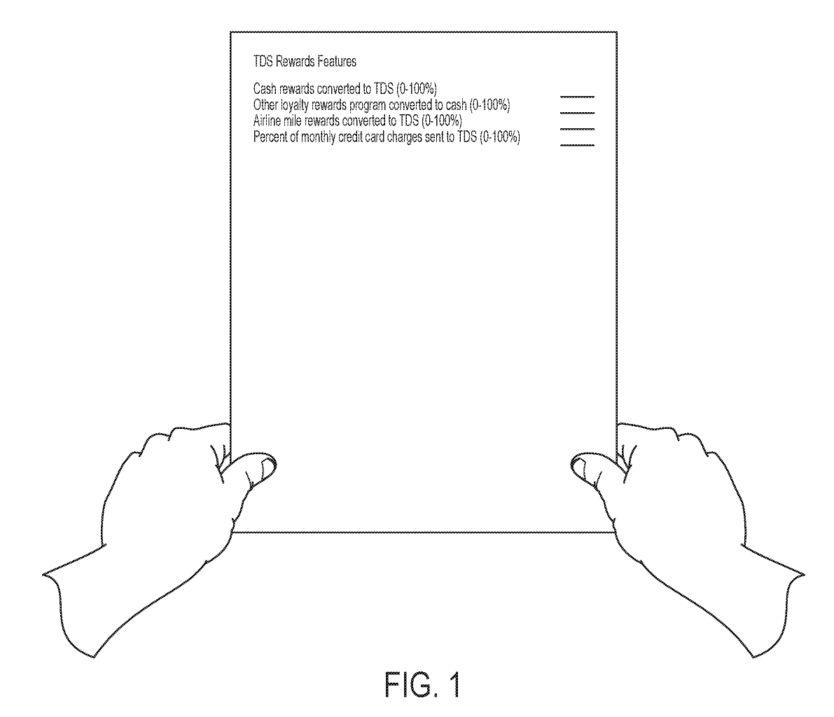

FIG. 2 shows a Statement illustrating a process for receiving selection criteria for one or more CCH-defined TDS plans based on risk strata, converting cash-back or other loyalty rewards programs to cash-equivalence, and electronically transmitting the funds to the CCH-defined TDS plan.

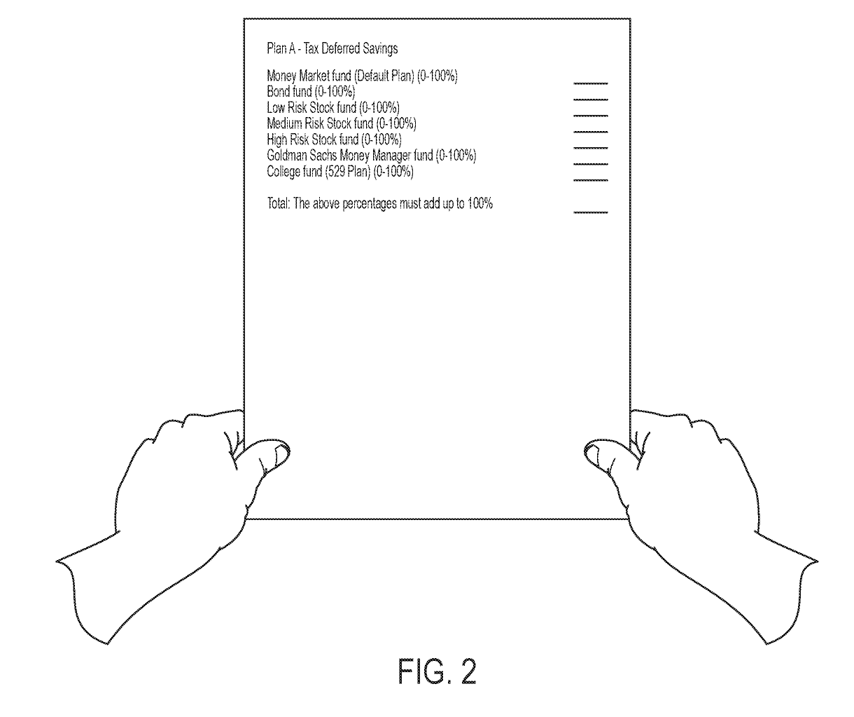

FIG. 3 shows Statements displaying an estimate of whether a CCH's savings or contribution goal will be achieved at the then-current funding or investment rate. The figure further depicts how, using the then-current annual percentage rate of the TDS plans selected and over 10, 18, 30, 40 years a figure will be estimated and allow CCHs to either change funds or add extra monies to the current distribution.

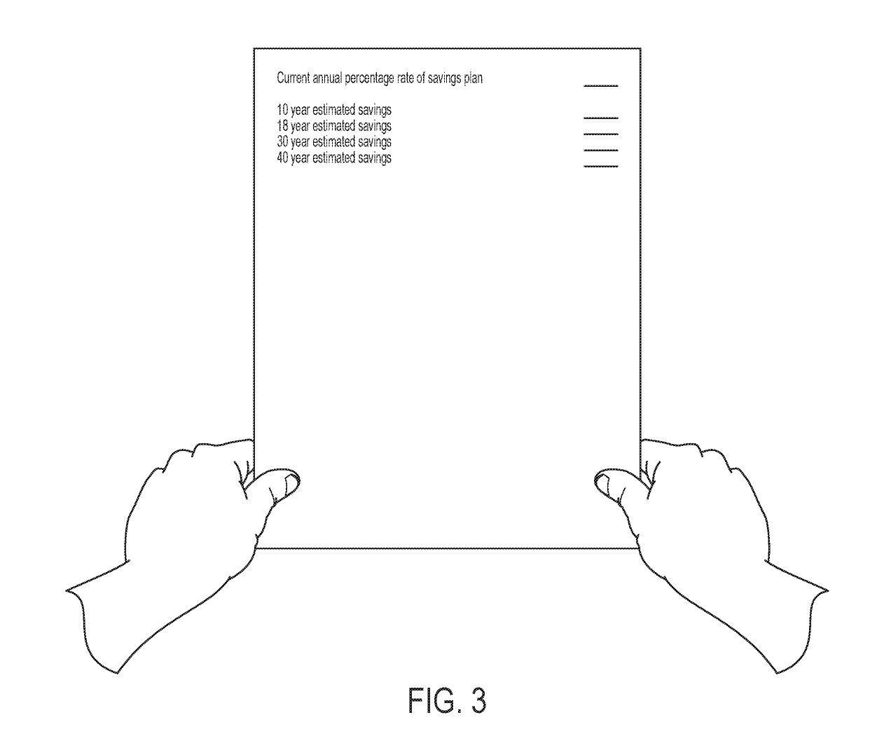

FIG. 4 shows an FAQ website provided by the credit card issuer, containing a calculator where CCHs can add monthly sums contributed and insert an assumed annual percentage rate, thereby allowing the calculator to produces an estimate for a period of years and providing CCHs an overview of the progress towards their respective goals. Answers to questions such as “what is a bond?”, “what is a stock?” or “how should one evaluate a fund?” should appear on the FAQ website. Aside from calculations, the FAQ website may also allow for self-education tutorials on financial terms or current issues. It may also serve as a forum for advertisement, or may be able to provide a platform for advertisers to reach an intended target or audience.

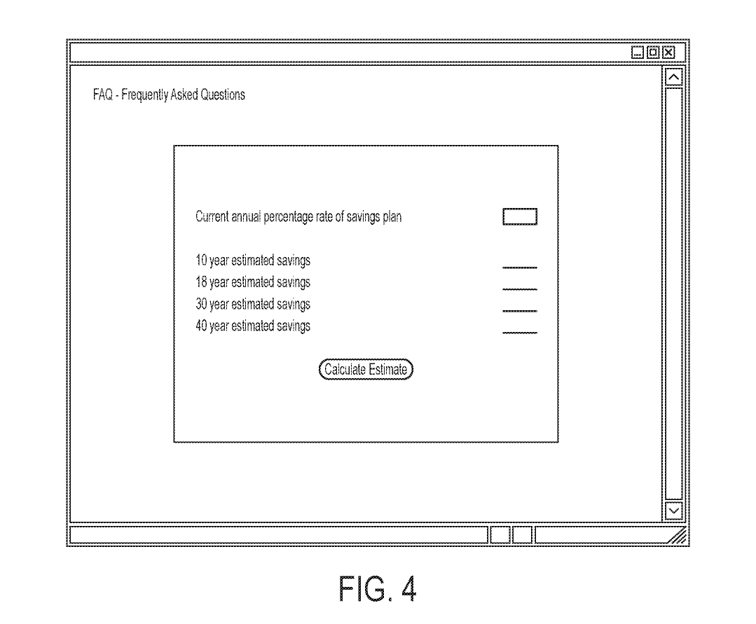

FIG. 5 shows the FAQ website which can be accessed via a portable device through a secure network.

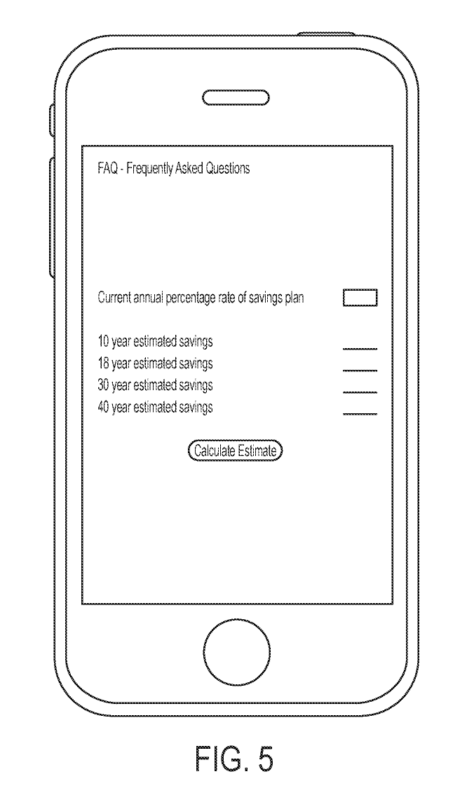

FIG. 6 shows a section of a Statement allowing for the transfer of funds between TDS accounts.

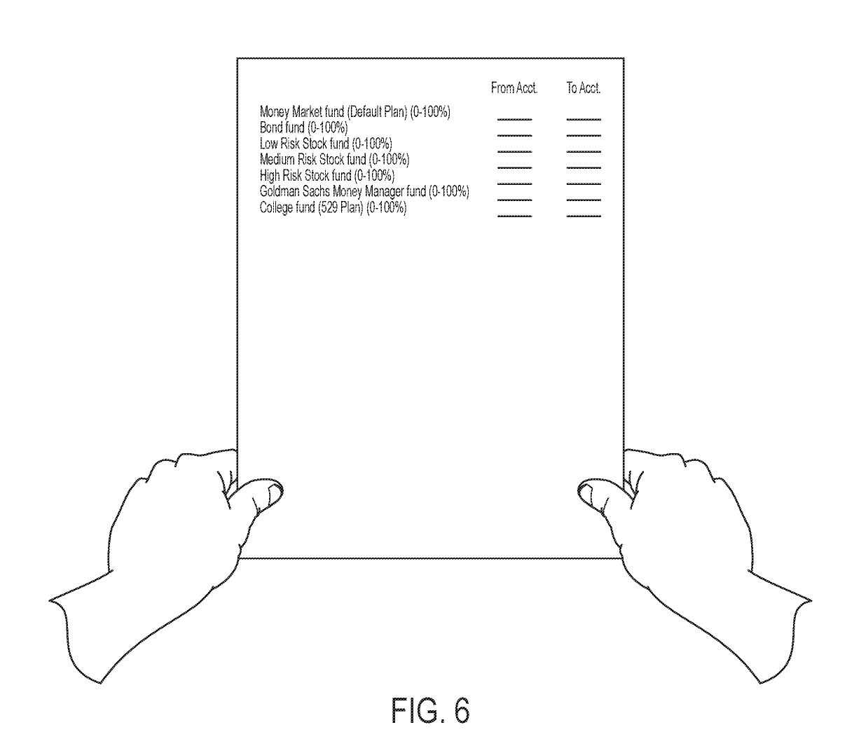

FIG. 7 shows a Statement denoted as Plan B, which are TDSs for third parties like employees or minor children, as shown on employer credit card statements, and allowing for the employer or contributor to control the amount of the contribution. FIG. 7 further depicts an employee-accessible website allowing the third parties, whether employees or minor children, or others, to manage the amount of the contribution, as well as the TDS to be used.

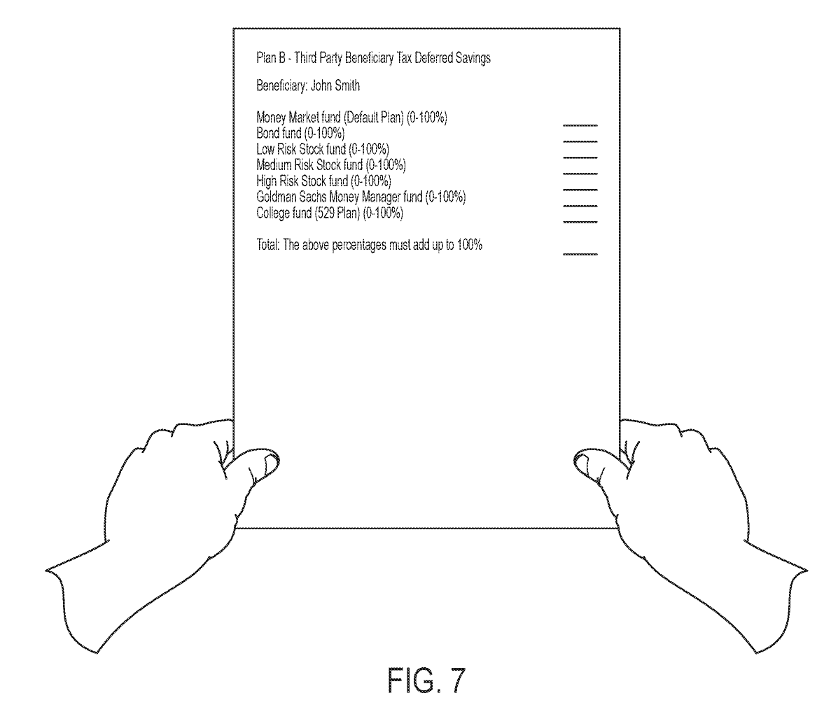

It should be understood to those of skill in the art that the statements shown in the accompanying Figures are not limited to a type of media, but may be disseminated over various media, whether print, electronic or other format not yet known or developed that allows for the periodic dissemination of information to consumers or clients.

### DETAILED DESCRIPTION OF THE INVENTION

In a preferred embodiment of the invention, a portable device provides a method which both uses a debt instrument, such as a credit card, and a savings instrument to fund a tax-deferred savings plan. In this preferred embodiment the financial institution that issues the credit card acts as a clearinghouse. The method includes providing a credit card statement including a section for the CCH to define a periodic contribution to a TDS. The method further provides creating a section within said credit card statement, which allows CCHs to select among one of a group of TDSs to receive the periodic monetary contribution, each representing a different level of risk. Optionally, the method includes providing the CCHs the option to allocate either (a) a percentage of the cash rewards provided by the credit card issuer that the CCH wishes to be deposited to TDS, (b) a percentage of any other loyalty rewards (converted to cash equivalency) that the CCH wishes to be deposited to a TDS, (c) a percentage of airline-mile rewards (converted to cash equivalency) that the CCH wishes to be deposited to a TDS, (d) a monthly cash sum the CCH wishes to be deposited into a TDS, or (e) a percentage of the CCH's monthly credit card spending total to be deposited into a TDS. It should be understood by those in the art that these options are not mutually exclusive, and that CCHs may be able to select one or more, either alone or in combination, and that each selection may change month to month, but may not change within the small billing unit credit card issuers set forth for their specific clients (i.e., a billing cycle).

In yet another preferred embodiment, during every transaction, the financial institution issuing the credit card covers the transaction price at the point of sale (i.e., the purchase price agreed to between the consumer and the vendor), and further deposits a percentage of the transaction price into a TDS previously selected by the credit-card holder, drawing this percentage from the CCH's line of credit.

In yet another preferred embodiment, the CCH is capable of selecting more than one periodic contribution to more than one TDS. In this preferred embodiment, the CCH is capable of creating, or selecting already-existing TDS accounts for both the CCH as well as others (i.e., friends, family members, employees, or other third parties whether natural persons or entities). If the CCH(s) elects to make contributions to tax deferred plans of employees, then employee(s) may be capable of managing the percentage of contribution, the type of TDS plan contributions made, and whether to transfer any amount from one such plan to another. The employer controls the amount of the contribution. If a CCH selects a TDS plan for the benefit of a minor such as a child or a grandchild, the guardian CCH would manages and oversee all aspects of the contribution process for the TDS account in the minor's stead until they come of age.

In this embodiment a method is provided for receiving a selection of one or more TDS plans based on risk strata, converting cash-back or other loyalty rewards programs to cash-equivalence, and electronically transmitting the funds to the CCH-defined TDS plan. The TDS plans may be any one of a group consisting of: money market funds, high risk stock funds, medium risk stock funds, low risk stock funds, bond funds, Goldman Sachs money manager fund, or a college savings plan (so-called “529 Plans”).

CCHs may select a percentage, up to a total of 100%, of each or a variable number of the group of TDS plans outlined above. Further, the method provides for a CCH selection of a stated savings goal, combined with a time frame for doing so. The method preferably includes displaying on subsequent statements an estimate of the savings amount the CCH will achieve at the current rate (percentage allocation) of contribution to the one or more tax deferred savings plans. For example, in the preferred embodiment the method may provide a balance sheet and state whether, at the current annual percentage rate of the TDS plans selected, and over a period of years, the target contribution will be reached, or alternatively whether an estimated amount will be reached. Alternatively, the method provides for a selection mechanism that allows the CCH to either change funds or add extra monies to the current distribution so as to achieve a desired target.

In yet another preferred embodiment, the CCH is capable of selecting more than one periodic contribution to more than one TDS. In this preferred embodiment, the CCH is capable of creating, or selecting already-existing TDS plans for both the CCH as well as others (i.e., friends, family members, employees, or other third parties whether natural persons or entities). Additionally, this preferred embodiment allows for the transfer of funds between accounts once the CCH achieves a minimum sum (pre determined by the credit card issuer) accumulating in various TDSs her or she may transfer some or all sums to one or more accounts.

In yet another preferred embodiment, the method provides a website maintained by a credit card issuer. The website is capable of computing an estimate of total savings for a specified period of time. These estimated totals would be based on CCHs input an assumed monthly sums saved, and an assumed annual percentage rate. This would allow the CCH the ability to understand, calculate and achieve his or her goal in a more proactive way. The website would also have educational tools servicing the consumers utilizing their services.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the CCH's computer, partly on the CCH's computer, as a stand-alone software package, partly on the CCH's computer and partly on a remote computer or entirely on the remote computer or server. In the latter scenario, the remote computer may be connected to the CCH's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

I claim:

1. A method for funding a tax-deferred account, the method comprising:
providing a credit card to a credit card holder;
generating a credit card statement;
providing the credit card statement to a credit card holder;
receiving, from said credit card holder, one or more selections made on the credit card statement;
transferring funds to a tax-deferred account, based on selections made by the credit card holder on the credit card statement.

2. The method of claim 1, wherein said credit card statement contains a blank space for a credit card holder to specify a desired monetary amount to be transferred to said tax-deferred account.

3. The method of claim 1, wherein said credit card statement displays a national currency equivalence of a credit card loyalty program balance associated to said credit card holder.

4. The method of claim 1, wherein said credit card holder can select all or a portion of a cash rewards program, a loyalty rewards program, an airline-mile rewards program, in national currency equivalence, to be transferred to said tax-deferred account.

5. The method of claim 1, wherein said credit card holder can specify in said credit card statement a percentage of the credit card holder's monthly total balance associated with said credit card to be contributed to said tax-deferred account.

6. The method of claim 1, wherein said credit card holder can specify in said credit card statement a percentage of each transaction associated with said credit card holder's credit card to be contributed to said tax-deferred account.

7. The method of claim 1, wherein said credit card statement displays tax-deferred account contribution and risk level associated with one or more of said tax-deferred accounts.

8. The method of claim 1, wherein said tax-deferred account is selected from a group comprising: money market funds, high risk stock funds, medium risk stock funds, low risk stock funds, bond funds, Goldman Sachs money manager fund, or a college savings plan.

9. The method of claim 1, wherein said credit card statement includes one or more sections where said credit card holder can fill in the name of the third party financial institution where said tax-deferred account is to be held.

10. The method of claim 1, wherein said tax-deferred accounts are arranged by their investment risk level.

11. The method of claim 1, wherein said credit card statement is provided to the card holder in printed format.

12. The method of claim 1, wherein said credit card statement is provided to the card holder in electronic format, and is accessed by the card holder via a web browser.

13. The method of claim 1, further comprising a listing of tax deferred accounts held by employees of the credit card holder.

14. The method of claim 1, further comprising a listing of tax deferred accounts held by family members of the credit card holder.

15. The method of claim 1, further providing the credit card holder the option of funding tax deferred accounts held by third parties.

16. The method of claim 1, further comprising providing a secure website for the credit card holder to make said selections.

17. The method of claim 1, further comprising providing a secure mobile application for the credit card holder to make said selections.

18. The method of claim 1, further comprising providing a telephone system for the credit card holder to make said selections.

19. The method of claim 1, further comprising providing multiple encrypted usernames and passwords to the credit card holder's employees to allow said employees to make said selections.

20. The method of claim 1, wherein said credit card holder is able to specify a fixed monetary contribution to be sent to his or her tax-deferred account.

21. The method of claim 20, wherein said fixed monetary contribution is adjusted at the end a billing cycle.

22. A portable device for funding a tax-deferred account, the portable device comprising:
a data storage device configured to store credit card statement information;
a process adjustment for tax-deferred optimization engine, executing as a processor of the portable device, the process adjustment for tax-deferred optimization engine communicatively coupled to the data storage device; and
process adjustment for tax-deferred logic comprising program code, when executed on the processor of the portable device, causes the process adjustment for tax-deferred optimization engine to generate a credit card statement, to provide the credit card statement to a credit card holder, to receive, from said credit card holder, one or more selections made on the credit card statement, and to transfer funds to a tax-deferred account, based on selections made by the credit card holder on the credit card statement.

23. The portable device of claim 22, wherein said credit card statement contains a blank space for a credit card holder to specify a desired monetary amount to be transferred to said tax-deferred account.

24. The portable device of claim 22, wherein said credit card statement displays a national currency equivalence of a credit card loyalty program balance associated to said credit card holder.

25. The portable device of claim 22, wherein said credit card holder can select all or a portion of a cash rewards program, a loyalty rewards program, an airline-mile rewards program, in national currency equivalence, to be transferred to said tax-deferred account.

26. The portable device of claim 22, wherein said credit card holder can specify in said credit card statement a percentage of the credit card holder's monthly total balance associated with said credit card to be contributed to said tax-deferred account.

27. The portable device of claim 22, wherein said credit card holder can specify in said credit card statement a percentage of each transaction associated with said credit card holder's credit card to be contributed to said tax-deferred account.

28. The portable device of claim 22, wherein said credit card statement displays tax-deferred account contribution and risk level associated with one or more of said tax-deferred accounts.

29. The portable device of claim 22, wherein said tax-deferred account is selected from a group comprising: money market funds, high risk stock funds, medium risk stock funds, low risk stock funds, bond funds, Goldman Sachs money manager fund, or a college savings plan.

30. The portable device of claim 22, wherein said credit card statement includes one or more sections where said credit card holder can fill in the name of the third party financial institution where said tax-deferred account is to be held.

31. The portable device of claim 22, wherein said tax-deferred accounts are arranged by their investment risk level.

32. The portable device of claim 22, wherein said credit card statement is provided to the card holder in printed format.

33. The portable device of claim 22, wherein said credit card statement is provided to the card holder in electronic format, and is accessed by the card holder via a web browser.

34. The portable device of claim 22, further comprising a listing of tax deferred accounts held by employees of the credit card holder.

35. The portable device of claim 22, further comprising a listing of tax deferred accounts held by family members of the credit card holder.

36. The portable device of claim 22, further providing the credit card holder the option of funding tax deferred accounts held by third parties.

37. The portable device of claim 22, further comprising providing a secure website for the credit card holder to make said selections.

38. The portable device of claim 22, further comprising providing a secure mobile application for the credit card holder to make said selections.

39. The portable device of claim 22, further comprising providing a telephone system for the credit card holder to make said selections.

40. The portable device of claim 22, further comprising providing multiple encrypted usernames and passwords to the credit card holder's employees to allow said employees to make said selections.

41. The portable device of claim 22, wherein said credit card holder can specify a fixed monetary monthly contribution to be sent to his or her TDS account.

42. The portable device of claim 41, wherein said fixed monetary monthly contribution can be adjusted at the end of a billing period.
